(19) United States
(12) Patent Application Publication
(10) Pub. No.: US 2006/0086356 A1
(43) Pub. Date: Apr. 27, 2006

(54) Oxygen bottle holder

(76) Inventor: Kurosh Nahavandi, Portage, MI (US)

Correspondence Address: FLYNN THIEL BOUTELL & TANIS, P.C., 2026 RAMBLING ROAD, KALAMAZOO, MI, 49008-1631, US

(21) Appl. No.: 11/252,652

(22) Filed: Oct. 18, 2005

Related U.S. Application Data
(60) Provisional application No. 60/620,932, filed on Oct. 21, 2004.

(51) Int. Cl. A62B 7/00; B60R 7/00

(52) U.S. Cl. 128/200.24; 128/205.22; 224/407; 224/42.39

(57) ABSTRACT

An oxygen bottle holder includes parallel longitudinal straps, secured together at one end to form a closure, transverse circumferential straps configured to secure the longitudinal straps together to define a cylindrical cavity, and a diametric stress relief strap. A pair of hook-and-loop fastening straps is secured to opposite ends of the longitudinal straps. Cooperating D-rings are configured for use with each of the fastening straps, and the fastening straps are configured to loop around a fixture and through the D-rings and self-adhere. A bottle securing strap is configured to secure an oxygen bottle within the cylindrical cavity.

### CROSS-REFERENCE TO RELATED APPLICATIONS

This application claims the benefit of U.S. Provisional Application Ser. No. 60/620,932, filed Oct. 21, 2004, which is incorporated herein in its entirety.

### FIELD OF THE INVENTION

The invention is related to an accessory mounting device for a patient support apparatus. More specifically, the invention relates to an oxygen bottle holder that is flexible, and collapsible when not in use, for mounting on a foldable patient support apparatus.

### DESCRIPTION OF RELATED ART

In the past, oxygen bottle holders have been provided that are rigid. In a folding chair, or in any folding patient support apparatus, when folded, the oxygen bottle holder is usually required to be removed. Also, the oxygen bottle holder will protrude unnecessarily when not in use.

It would be advantageous to provide an oxygen bottle holder that does not protrude when not in use. It would be further advantageous to provide an oxygen bottle holder that does not require removal prior to folding a patient support apparatus.

### BRIEF SUMMARY OF THE INVENTION

A bottle holder includes a plurality of elongate flexible members joined by a plurality of transverse members to define an elongate cavity, and at least one fastening element at each end thereof to secure the bottle holder to a fixed article.

### BRIEF DESCRIPTION OF THE SEVERAL VIEWS OF THE DRAWINGS

The present invention will become more fully understood from the detailed description and the accompanying drawings, wherein:

FIG. 1 is a perspective view of an oxygen bottle holder according to the invention.

FIG. 2 is an elevational view of the oxygen bottle holder of FIG. 1.

FIG. 3 is a top plan view of the oxygen bottle holder of FIGS. 1-2.

FIG. 4 is a bottom plan view of the oxygen bottle holder of FIGS. 1-3.

FIG. 5 is a side view of a patient support apparatus with a mounted oxygen bottle holder according to FIGS. 1-4.

FIG. 6 is a partial cross-sectional view taken through line 6-6 of FIG. 5.

FIG. 7 is a side view of the patient support apparatus of FIG. 5 in a folded condition.

### DETAILED DESCRIPTION OF THE INVENTION

Certain terminology will be used in the following description for convenience in reference only and will not be limiting. The words “up”, “down”, “right”, “left”, “clockwise” or “counterclockwise” will designate directions in the drawings to which reference is made. The words “in” and “out” will refer to directions toward and away from, respectively, the geometric center of the device and designated parts thereof. Such terminology will include derivatives and words of similar import.

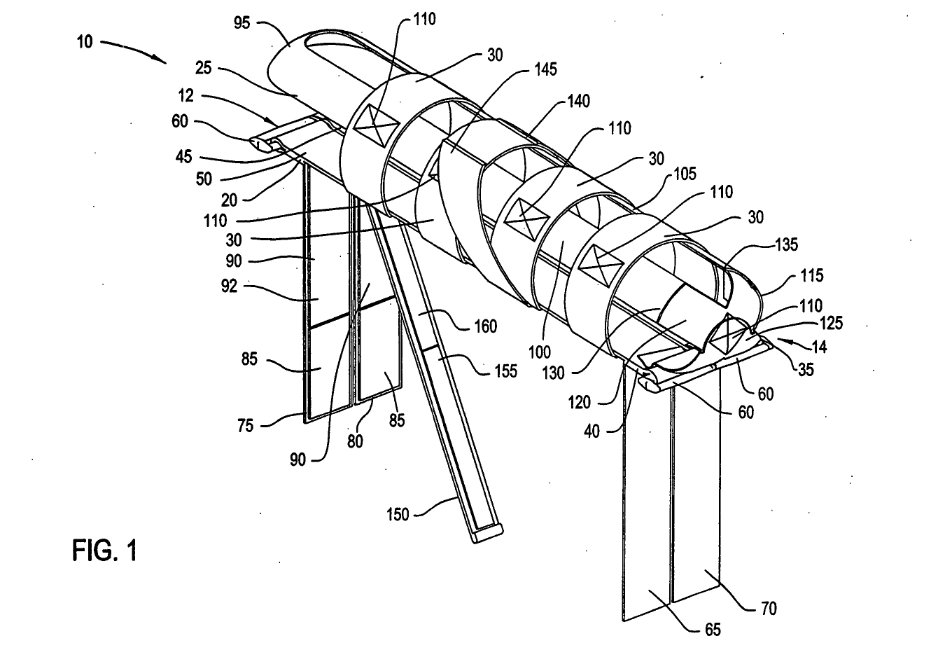

Referring to FIGS. 1-3, an oxygen bottle holder 10 according to invention is illustrated, having an opening end 12 and a closure end 14. The oxygen bottle holder 10 is formed from a pair of longitudinal flexible base straps 15, 20 and an upper strap 25. The base straps 15, 20 and the upper strap 25 are joined by a plurality of circumferential elastic bands 30. The oxygen bottle holder 10 is formed of flexible materials to make it readily collapsible for storage or transport, but is illustrated in a fully deployed, cylindrical configuration, wherein the base straps 15, 20, the upper strap 25 and the circumferential elastic bands 30 define a substantially cylindrical cavity 32 for receiving an oxygen bottle (not shown).

The base straps 15, 20 are configured and secured in a parallel orientation, each base strap 15, 20 having a closure end 35, 40 and an opening end 45, 50. The base traps 15, 20 are formed with a loop 55 at each respective closure end 35, 40 or opening end 45, 50 for securing a buckle member 60.

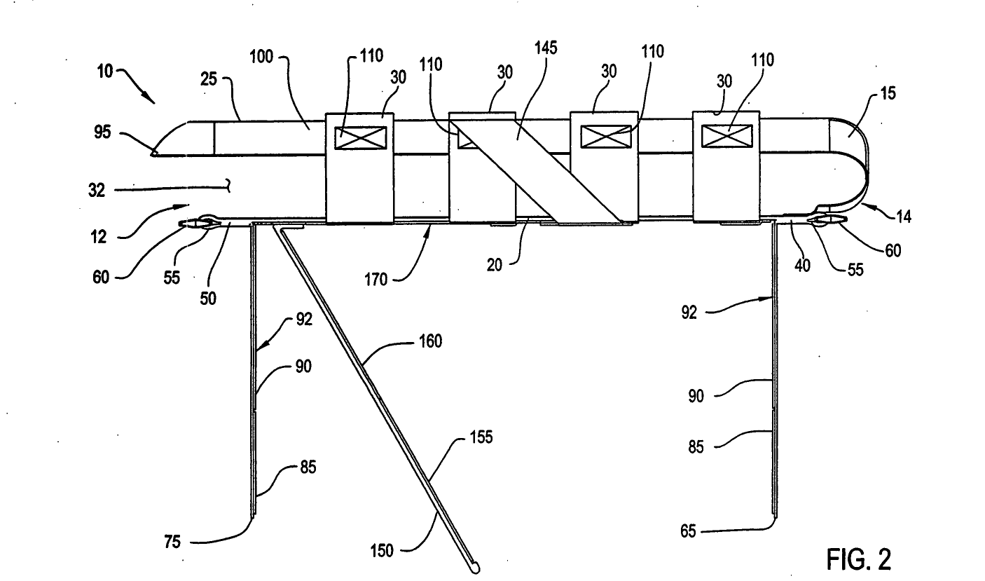

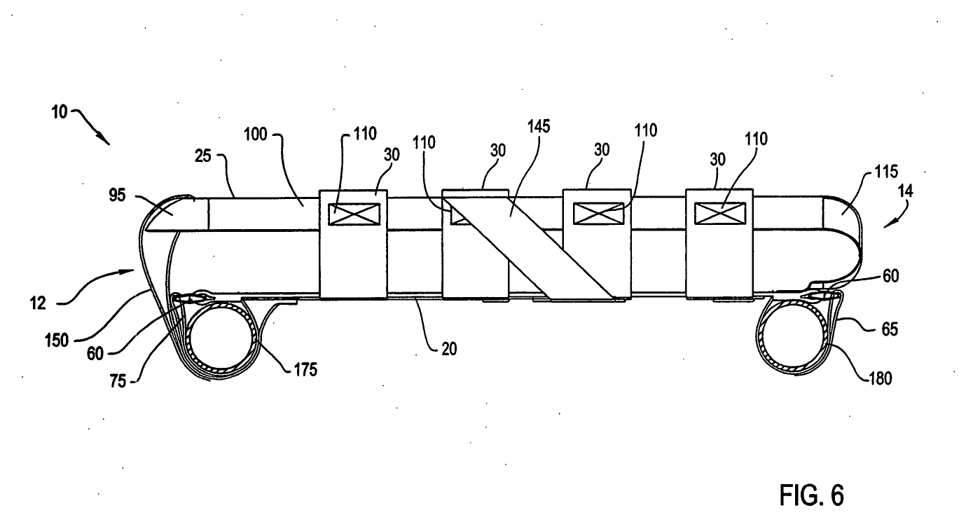

Referring to FIGS. 1-2, a tie-down strap 65, 70, 75, 80 is secured to each of closure end 35, 40 and opening end 45, 50 of the base straps 15, 20. In the illustrated embodiment, the tie-down straps 65, 70, 75, 80 are formed continuously with the base straps 15, 20. Each end of the base straps 15, 20 is passed through the respective buckle member 60, and the loop 55 sewn in the strap 15, 20 to secure the buckle member 60. The base straps 15, 20 are passed far enough through the buckle members 60 so that the excess portion forms the tie-down straps 65, 70, 75, 80. The tie-down straps 65, 70, 75, 80 are further configured with a hook-and-loop fastening system 85, 90 on an inner face 92. Each tie-down strap 65, 70, 75, 80 is provided with both the hook portion 85 and the loop portion 90 of the hook-and-loop fastening system 85, 90, so that each tie down strap 65, 70, 75, 80 can be secured to itself after passing through a respective buckle member 60 (FIG. 6).

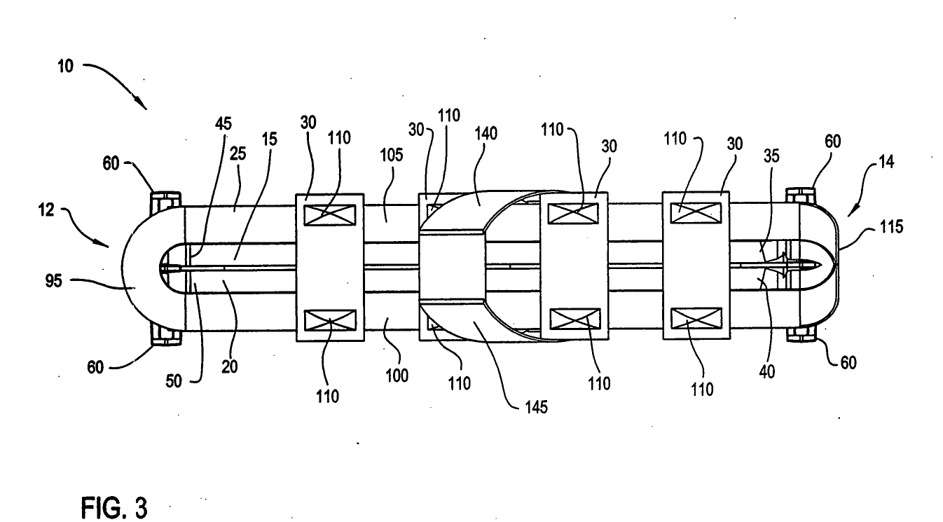

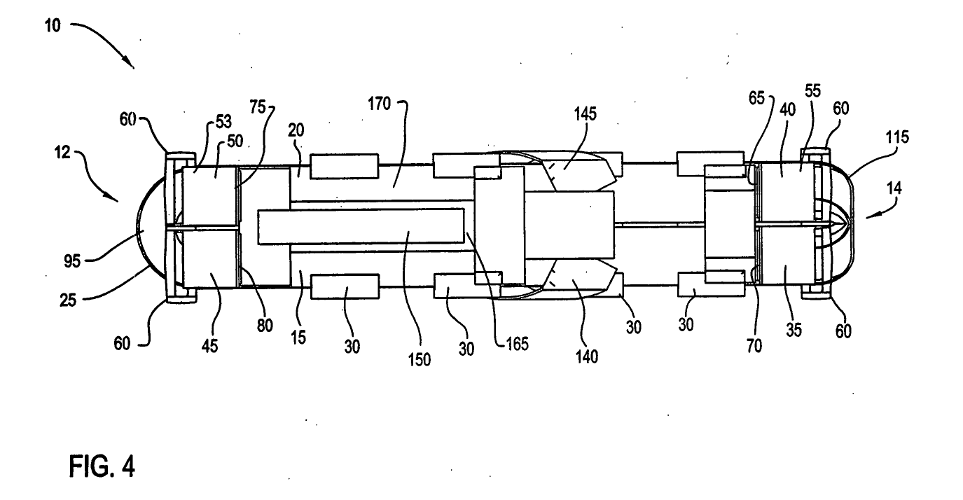

Referring now to FIGS. 3-4, the upper strap 25 is formed in a “U” shape, with a bight portion 95 positioned at the opening end 12 of the oxygen bottle holder 10. Each leg 100, 105 of the “U” extends longitudinally along the oxygen bottle holder 10, parallel with the base straps 15, 20, and is secured to the circumferential elastic bands 30, such as by stitching 110. It is also anticipated that the base straps 15, 20 and the upper strap 25 can be secured to each other and to the elastic band 30 by other means, such as welding, riveting, gluing, or other mechanical or adhesive bonding methods.

At the closure end 14 of the oxygen bottle holder 10, the base straps 10, 15 and the upper strap 25 are further joined by a closure member 115. The closure member 115 can be formed of one or more straps 120, 125 or flexible bands secured together in an “X” pattern as shown, or can be formed continuously from the closure ends 130, 135 of the upper strap 25, which would then be crossed and secured to the base straps 15, 20. The closure member 115 is secured to each of the base straps 15, 20 and the upper strap 25 by stitching or one of the other methods discussed above.

The base straps 15, 20 and the upper strap 25 are further joined by a pair of stress relief straps 140, 145. As illustrated, the stress relief straps 140, 145 are joined to the base straps 15, 20 and the upper strap 25 on a diagonal about the circumference of the oxygen bottle holder 10, connecting to the respective straps 15, 20, 25 at adjacent circumferential elastic bands 30. The stress relief straps 140, 145 are formed of a non-elastic material for the purpose of inhibiting longitudinal displacement of the upper strap 25 relative to the base straps 15, 20. In a preferred embodiment, the stress relief straps 140, 145 are formed of the same or similar material as the base straps 15, 20 or the upper strap 25.

The oxygen bottle holder 10 further includes a bottle securing strap 150 secured to at least one of the base straps 15, 20 proximate the opening end 12 of the oxygen bottle holder 10. The bottle securing strap 150 is provided with a hook-and-loop fastening system 155, 160 after the same fashion as the tie-down straps 65, 70, 75, 80. The bottle securing strap 150 is configured to pass through the bight portion 95 of the upper strap 25 and fold back upon itself, with the hook-and-loop fastening system 155, 160 securing the strap 150. The securing strap 150 thereby holds an oxygen bottle in the cavity 32 defined by the base straps 15, 20, the upper strap 25 and the circumferential elastic bands 30. A hook-and-loop section 165 is further provided on an underside 170 of the oxygen bottle holder 10 (see FIG. 4) for securing the bottle securing strap 150 when not in use.

### Operation

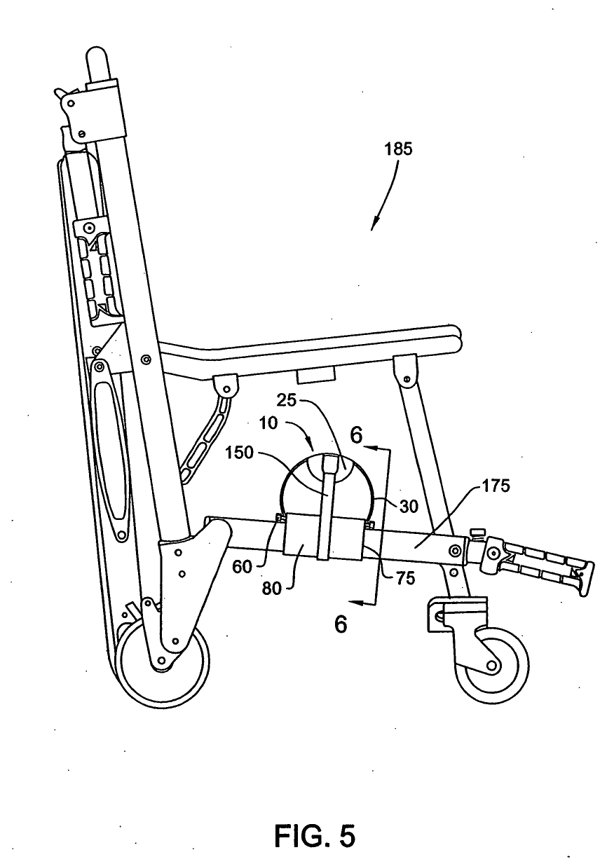

Referring now to FIGS. 5-7, the oxygen bottle holder 10 is secured to a pair of opposing cross-members 175, 180 of a patient support apparatus 185. The length of the base straps 15, 20 or, more specifically, the distance between the buckle members 60 of the oxygen bottle holder 10 is configured in length to closely span the distance between the cross members 175, 180. As shown in Figure YY, each tie-down strap 65, 70, 75, 80 is routed underneath and around a respective cross-member 175, 180 and through a corresponding buckle member 60. The tie-down strap 65, 70, 75, 80 is then folded back on itself to self adhere using the hook-and-loop fastening system 85, 90. The oxygen bottle holder 10 is thereby secured to the patient support apparatus 185, and ready to receive an oxygen bottle.

An oxygen bottle (not shown) is inserted through the opening end 12 of the oxygen bottle holder 10, bottom end first. As the oxygen bottle is inserted into the cavity 32 of the oxygen bottle holder 10, the bottom end of the bottle will slide along and be supported by the base straps 15, 20, which are supported in tension between the cross members 175, 180. The base straps 15, 20 and the upper strap 25, which are inward of the circumferential elastic bands 30 in the cavity 32, cooperate to guide the oxygen bottle into the cavity 32 so that it does not catch on the bands 30.

An attendant will, in an intuitive fashion, grasp the bight portion 95 of the upper strap 25 to hold the opening end 12 of the oxygen bottle holder 10 open for insertion of the oxygen bottle. Due to the non-rigid nature of the oxygen bottle holder 10, the attendant grasping the bight portion 95 of the upper strap 25 will tend to collapse the cavity 32, and draw the upper strap 25 toward the opening end 12 of the oxygen bottle holder 10. Since the upper strap 25 is secured to the closure member 115, the closure member 115 will also be drawn toward the opening end 12. With the closure member 115 thus displaced, the attendant will have difficulty fully seating the oxygen bottle within the oxygen bottle holder 10.

In order to prevent displacement of the upper strap 25 and the closure member 115, the stress relief straps 140, 145 are provided. The stress relief straps 140, 145 join the upper strap 25 to the base straps 15, 20 at an angle to provide a longitudinal anchor for the upper strap 25. With the base straps 15, 20 secured to the cross members 175, 180, the stress relief straps 140, 145 thereby prevent significant longitudinal movement of the upper strap 25. The upper strap 25 therefore does not displace the closure member 115, enabling the attendant to fully insert the oxygen bottle into the oxygen bottle holder 10.

As shown in FIG. 6, with the oxygen bottle fully inserted into the cavity 32, it is supported at the closure end 14 of the oxygen bottle holder 10 by the cross-member 180. The oxygen bottle is further supported at the opening end 12 of the oxygen bottle holder 10 by the cross-member 175.

With the oxygen bottle fully inserted into the oxygen bottle holder 10, the valve system of the oxygen bottle extends through the opening end 12, readily accessible to the attendant for adjustment and attachment of tubing. The oxygen bottle is secured in the oxygen bottle holder 10 by the bottle securing strap 150. After the oxygen bottle has been fully inserted into the oxygen bottle holder 10, the bottle securing strap 150 is released from the hook-and-loop section 165 on the underside 170 of the oxygen bottle holder 10. The bottle securing strap 150 is then routed around the cross-member 175 and through the bight portion 95 of the upper strap 25. The bottle securing strap 150 is then folded back upon itself and secured using the hook-and-loop fastening system 155, 160.

The oxygen bottle can be released from the oxygen bottle holder 10 in a reverse fashion, whereby the hook and fastening system 155, 160 of the bottle securing strap 150 is released, and the bottle securing strap 150 removed from the bight portion 95 of the upper strap 25. The bottle securing strap 150 can then be stored on the hook-and-loop portion 165 on the underside 170 of the oxygen bottle holder 10. The oxygen bottle is then removed from the oxygen bottle holder 10, which can remain mounted to the cross-members 175, 180.

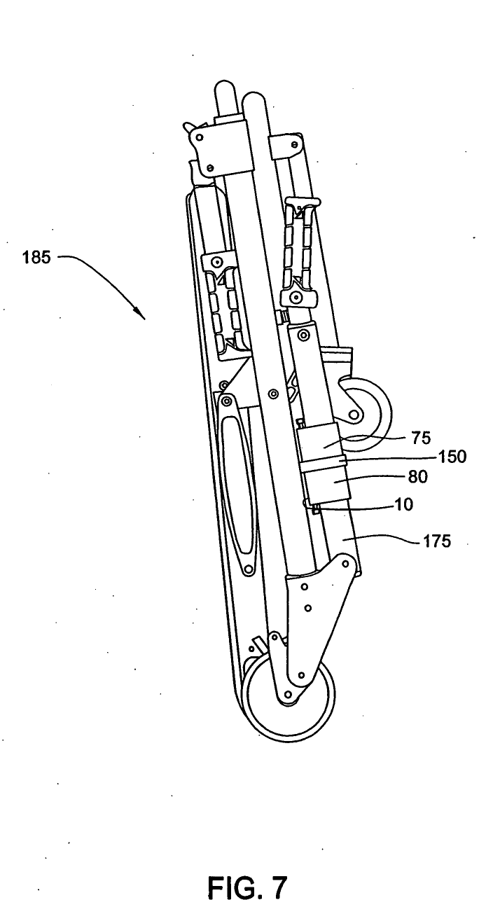

In a situation where the patient support apparatus is foldable or collapsible, the oxygen bottle holder 10 can be left installed when the apparatus is folded due to the flexible and collapsible nature of the oxygen bottle holder 10. An example of such an arrangement is illustrated in FIG. 7, wherein the patient support apparatus 185 has been folded with the oxygen bottle holder 10 in place.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the scope of the appended claims.

What is claimed is:

1. An oxygen bottle holder, comprising:
a plurality of parallel longitudinal straps, secured together at one end to form a closure;
a plurality of transverse circumferential straps, configured to secure the longitudinal straps together to define a cylindrical cavity;
at least one diametric stress relief strap;
a pair of hook-and-loop fastening straps, at least one secured to opposite ends of one of the plurality of longitudinal straps;
cooperating buckle members configured for use with each of the fastening straps, the fastening straps configured to loop around a fixture and through the buckle members and self-adhere; and
a bottle securing strap configured to secure an oxygen bottle within the cylindrical cavity.

2. The oxygen bottle holder according to claim 1, wherein one of the plurality of longitudinal straps forms a bight adjacent to an open end of the cylindrical cavity.

3. The oxygen bottle holder according to claim 2, wherein the bottle securing strap is configured to pass through the bight for securing an oxygen bottle within the cylindrical cavity.

4. The oxygen bottle holder according to claim 3, the bottle securing strap further comprising fastening sections for self-adherence upon passing through the bight.

5. The oxygen bottle holder according to claim 4, the fastening sections further comprising a hook-and-loop fastening system.

6. The oxygen bottle holder according to claim 1, wherein the longitudinal straps are secured to an inner side of the transverse circumferential straps.

7. A method of attaching an oxygen bottle to a patient support apparatus, comprising the steps of:
providing an oxygen bottle holder comprising:
a plurality of parallel longitudinal straps, secured together at a first end to form a closure;
a plurality of transverse circumferential straps, configured to secure the longitudinal straps together to define a cylindrical cavity;
at least one diametric stress relief strap;
a pair of self-adhering hook-and-loop fastening straps, at least one secured to each of opposing ends of the plurality of longitudinal straps;
cooperating buckle members configured for use with each of the fastening straps, the fastening straps configured to loop around a fixture and through the buckle members and self-adhere; and
a bottle securing strap configured to secure an oxygen bottle within the cylindrical cavity;
securing the oxygen bottle holder to the patient support apparatus using the self adhering hook-and-loop fastening straps;
inserting a bottom end of an oxygen bottle into an open end of the oxygen bottle holder, and sliding the oxygen bottle into the cavity; and
securing the oxygen bottle within the oxygen bottle holder by passing the bottle securing strap through a second end of one of the plurality of parallel longitudinal straps and fastening the bottle securing strap in place.
